(19) United States
(12) Patent Application Publication
(10) Pub. No.: US 2017/0036957 A1
(43) Pub. Date: Feb. 9, 2017

(54) Treatment/disposal of gas drilling wastewater by admixing with concrete and related end products

(71) Applicant: Philip X. Masciantonio, Jeannette, PA (US)

(72) Inventor: Philip X. Masciantonio, Jeannette, PA (US)

(21) Appl. No.: 15/203,411

(22) Filed: Jul. 6, 2016

Related U.S. Application Data
(60) Provisional application No. 62/190,009, filed on Jul. 8, 2015.

(51) Int. Cl. C04B 18/04; C02F 1/68

(52) U.S. Cl. CPC C04B 18/049; C02F 1/68; C02F 2103/10

(57) ABSTRACT

Treatment and disposal of wastewater from gas drilling by admixing with concrete produces a commercial product with a large market and involves no energy or generation of waste materials. The invention has unique cost saving opportunities to gas drilling operations but also to the concrete industry. Methods of treatment and wastewater disposal are claimed along with particular concrete products made using such wastewater additives.

### CROSS-REFERENCE TO RELATED APPLICATION

This is a perfection of Provisional Application Ser. No. 62/190,009, filed on Jul. 8, 2015, the disclosure of which is fully incorporated by reference herein.

### BACKGROUND OF THE INVENTION

The production of natural gas from Marcellus and other shale deposits involves deep well drilling (approximately 5,000 feet deep) at high pressure using large amounts of water containing sand 9% and chemicals (oil, gums, salt 5%). Approximately 24 MM gallons of water are used in a typical fracking well process, much of which is recovered and recycled during the process before discharge. However, there are about several million gallons per well that must be removed from the system. This is frack wastewater. That frack water must be handled in such a manner as to not cause environmental problems. It must be treated to remove impurities before discharge or taken to a “deep well” for disposal. These disposal systems are not always practical and generally are quite expensive for well drillers. Other current systems for treating such frack waters are complicated and require large amounts of electrical energy, chemical treatments and/or transportation.

Environmental concerns with operating such treatment systems include: added air, noise and light pollution, increased vehicular traffic, radiation potential, frack water handling/recycling, water treatment and subsequent disposal into deep wells. Unfortunately, future deep well disposal alternatives may be limited by the ongoing availability of such wells. Wastewater discharge into a sewage plant is not feasible; little or no improvement results. Hence, there is an urgent need for a new technology with no discharge.

The present invention, tentatively marketed under the name EcoSafe Frack Lock or ESFL^{SM} technology, is unique in that it will produce a commercial product with its own large market. Yet, it requires no additional energy and generates no new waste materials. The invention has unique cost saving opportunities for gas drilling operators and for the concrete industry as a whole.

### RELEVANT ART

Noteworthy to this invention are the following references:
1) Masciantonio et al, U.S. Pat. No. 3,567,476 entitled “Method of Coloring Bituminous Materials”;
2) Integrated Treatment for Frack Water Management, www.ecologyexsystems.com/systems
3) Marcellus Shale Waste Water, Water Issues In Pennsylvania, Penn State Extension, http://extension.psu.edu/natural-resources/water/marcellus-shale/waste-water/current-and-emerging-treatment-and-disposal-technologies
4) Use of Recycled Water In Concrete Production, August 2007, Cement Concrete and Aggregate.
5) High Radiation Not A By-Product of Drilling, DEP, http://powersource.post-gazette.com/powersource/consumers-p
6) Concrete: Scientific Principles, http://matsel.malse.Illinois.edu/comcrete/prin.litml

### BRIEF SUMMARY OF THE INVENTION

As stated above, gas and oil drilling generates large quantities of fracking wastewater (or frack water). Typical disposal of such contaminated water is quite costly. The present invention offers a low cost solution to this problem. It avoids disposal by first ascertaining what contaminants are present in any given wastewater stream, adding effluent(s) particular to those contaminants to the wastewater, then mixing such waters with appropriate quantities of concrete mix thereby firmly binding the contaminated water in a permanent concrete matrix. The resulting concrete product can be used commercially without adverse environmental impact.

The claimed invention differs from what currently exists. Current disposal and treatments of gas drilling wastewater involve deep well disposals, chemical treatments, reverse osmosis, and distillation, and other complicated/expensive techniques. This invention totally eliminates the need for disposing of contaminated water while producing a valuable commercial concrete.

The invention is unique in producing commercial product with a large market and involves no energy or waste materials. The invention has unique cost saving opportunities to gas drilling operations but also to the concrete industry at large.

The invention utilizes frack wastewater in the production of commercially useful concrete products by a combination of physical and chemical processing in normal concrete production systems. The technology not only provides an environmentally safe, yet practical solution to the “frack water” problem, it allows for water conservation in addition to cost savings relating to the overall requirements for water conservation. It thereby saves significantly on the cost of fracking water treatment and disposal. It is expected that cost savings realized through this invention may be transferred on to well drillers and concrete manufacturing facilities. And little additional capital facility costs should be required.

### BRIEF SUMMARY OF THE DRAWINGS

Further features, objectives and advantages of this invention will be clearer with the following detailed description made with reference to the accompanying drawings in which:

FIG. 1 is a flowchart depicting a typical gas and oil drilling system, its main fuel products to the right side and the treatment of wastewaters therefrom according to the invention along the left margin of the same; and

FIG. 2 is a perspective view of a representative well casing showing its cement components some of which can be made using wastewater-containing concrete according to preferred embodiments of this invention.

### DETAILED DESCRIPTION OF PREFERRED EMBODIMENTS

The invention is unique in that it produces useful product by combining wastewaters and a concrete mix in such a manner as to completely incorporate the potentially hazardous materials into a safe concrete end product. It uses surfactant agents to emulsify fracking or frack water in such a manner as to completely bind the contaminants of that water into a concrete matrix. Tests specimens of a wide variety of materials in the water indicate that by proper control of the materials, there is no subsequent leaching of the contaminants after the concrete mix has been aged a set time. Normal mixing procedures for the concrete industry may still suffice in adapting this invention to standard industry practices.

### Relationship Between Components:

The elements of the invention include the combining of wastewater from gas and oil drilling, after emulsification with a surfactant, with an appropriate commercial concrete mixing composition. The result is a concrete end product that safely incorporates previously hazardous frack water residues therein.

Various materials may be included within that concrete mix depending on the product desired for a specific commercial application. The studies completed as part the trials for the invention indicate that a wide range of end use applications is feasible.

### How the Invention Works:

The invention recognizes the unique properties of concrete in an unusual matrix and the wide range of raw materials that can be utilized for obtaining physical properties and various chemical characteristics. This invention will exploit the additions of known or subsequently developed surfactants (and their related colloidal chemistries) to solve what is an ever-growing environmental problem today. Accordingly the invention has found a unique and unexpected combination of cementatious materials that captures impurities in wastewaters, after emulsification, and immobilizes those materials in a concrete end porduct. This invention should achieve a totally unexpected result especially compared to literature predictions that water impurities may impart serious adverse impacts on the properties of such products.

### How to Make the Invention:

The invention employs a process wherein wastewater from gas wells is mixed in appropriate quantities with cement, aggregate, and certain additives (i.e., surfactants) for imparting such desired characteristics as strength, durability, abrasive resistance, chemical resistance, and other surface/physical properties to the resultant end product. It is particularly important that the processes utilized in in the invention are implemented in such a manner as to introduce the water and concrete mix with appropriate additives pre-determined for the composition of that “starting” wastewater. The cure time and mixing of constituents will enter into the proper binding of all components (including the wastewater) into a concrete matrix.

The invention should have considerable flexibility with regard to workability. It is expected that the compositions of wastewater from gas well drilling will have considerable variability. Accordingly, preliminary screening of water composition should prove useful particularly for finding/learning what contaminants are contained therein and the relative levels of each to one another. Certain additives that can impact a colloidal or surfactant behavior on each of those contaminants would be expected to improve performance. Common surfactants include sodium stearate and dodecyl benzene compounds.

It would be expected that the invention could be modified or favorably impacted by changes in additives, concrete variability, mixing sequence, and temperature variations and cure time. Still further benefits may be realized by purposefully compensating for known or expected variations in concrete mix feedstock.

### How to Use the Invention:

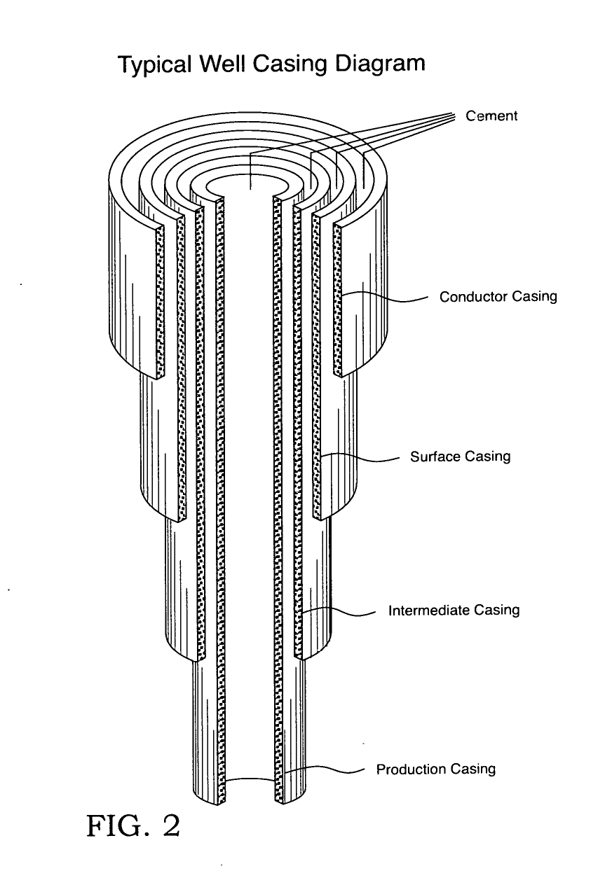

The invention can be used to solve still other problems that involve the disposal of contaminated water from other industrial operations. The use of such waters in the production of commercial quality concrete products may enable the building and operation of concrete-making facilities in conjunction with the normal operation of a manufacturing operation that generates contaminated waters. In other words, it is foreseeable that, through this invention, one can possibly imagine building a concrete manufacturing/mixing facility at or near (adjacent) a gas and oil drilling operation for the “in situ” manufacture of concrete products using freshly generated wastewaters. At least one such end product use for such concrete applications would be those casings otherwise used about the drilled well hole of a fracking drilling operation. A representative example of such casings is shown in accompanying FIG. 2.

### EXAMPLES

Initial bench scale experiments on ESFL technology involved running tests with common industrial chemicals; salts, mineral oils, vegetable oils as well as using frack water samples from several drilling sites.
Tests with various wetting agents and colloidal materials utilizing varying concrete set times.
The odors and hardness of samples were compared to evaluate relative effectiveness.
Extraction tests were performed on concrete samples.
Preliminary considerations and tests on radiation from concrete samples.

The demonstration of the ESFL Technology consisted of 28 experiments over 14 months that involved the use of ordinary concrete mix (sand as the aggregate) combined with water and certain additives (wetting agents and other colloidals and surfactants). The concrete samples that were produced were allowed to cure at room temperatures (60-80° F.) for time periods ranging from 2 hours to 2 weeks and were examined for hardness, color, extraction (solubility), extract color, odor, and general appearance. Because of the small sample size it was not possible to conduct conventional testing of the specimen (slump test, compression study, strength tests, etc.)

What is still needed is to prepare specific concrete products for various applications such as highway barriers, driveways, sidewalks, cement block, decoratives, etc.—and then examine each product for any residual properties of concern.

### I. Summary of Test Data

A. Samples of concrete prepared with bottled water and other substances

B. Samples of concrete prepared from frack water samples

C. Tests on frack water with subsequent extraction tests

### Chemical Mechanism

It is noteworthy that the primary concern of the ESFL system is the utilization of the concrete matrix to permanently capture the frack water impurities (i.e. permanently capture the myriad of chemicals and other substances that are essential to the fracking process to release methane gas from the Marcellus Shale). Once the chemicals and other substances in the frack water are emulsified they can be readily captured during the hydration process in the concrete during the cures—permanently binding the chemicals and suspended solids that make up the impurities that constitute frack water.

### Preparation of Concrete Frack Water Samples

The sequence followed in test procedures involved placing about ¼ ounce of subject water sample in a 16 oz. plastic container then adding 2-3 drops of liquid detergent, or a colloidal substance such as bentonite. The blend of water and surfactant was vigorously mixed to emulsify the sample. Approximately four ounces of concrete mix was added to the water/surfactant solution and the sample mixed to get a material that is uniformly homogenized. The material was then allowed to cure in a plastic container for an appropriate time prior to further testing of the sample.

### Testing of Cured Concrete Samples

Samples of cured concrete were tested over time periods from 2 hours to 2 weeks for characteristics related to effectiveness regarding the capture of water contaminants in the concrete matrix. All of these tests were only qualitative since desirable quantitative test criterion was not feasible.

In this regard, color of extracts, odor, and appearance were determined and rated for each experiment. The data are tabulated below:

Summary of Selected Experimental Data*

| | | Cure | Hard- | Sample | Extract | Appear- |
|---|---|---|---|---|---|---|
| Sample | Mix | Time | ness | Odor | Odor | ance |
| I | Water/ | 8 | 10 | 1 | — | — |
| | Cement mix | | | | | |
| II | Frack water1 | 8 | 10 | 1 | 1 | 1 |
| | Cement mix | | | | | |
| III | Frack water 1 | 8 | 5 | 1 | — | — |
| | Cement mix | 24 | 10 | 1 | 1 | 1 |
| | Surfactant | | | | | |
| IV | Frack water 1 | 24 | 10 | 1 | 1 | 1 |
| | Cement mix | | | | | |
| | Bentonite | | | | | |
| V | Frack water 2 | 8 | 5 | 1 | — | — |
| | Cement mix | 24 | 10 | 1 | — | — |
| | Surfactant | | | | | |
| VI | Frack Water 2 | 8 | 5 | 5 | — | — |
| | Cement mix | 24 | 10 | 1 | — | — |
| | Bentonite | | | | | |

*Several duplicate samples were conducted over a period of 14 months

| | | |
|---|---|---|
| 1) Rated | 1, 5, 10 | (Poor, Hard, Very Hard) |
| 2) Time (hours) | 2, 8, 24 | |
| 3) Mix Odor | 10, 5, 1 | (Strong, Moderate, None) |
| 4) Water Extract Odor | 10, 5, 1 | (Strong, Moderate, None) |
| 5) Water Extract Appearance | 10, 5, 1 | (Dark, Slight, None |

Inspection of the experimental data confirms literature reports that the addition of salts such as NaCl and CaCl₂ has little or no adverse effect on the concrete products. Furthermore, it appears that the considerable odor of the frack water is completely absent from the concrete after curing. Significantly, extracts from concrete drilling samples show no color or odor of frack water chemicals.

It appears that all the frack water chemicals are permanently bonded in the concrete matrix. Accordingly, it would be expected that concrete products produced from the ESFL system should be commercially useful.

The invention uses a method wherein wastewater from gas wells is mixed with appropriate quantities of chemical additives for imparting such properties as strength, durability, abrasion resistance and other significant surface and/or physical properties (including color and texture additives). It is particularly important that the system is implemented in such a manner as to combine frack water mixtures with appropriate additives determined by the specific compositions of that wastewater.

The invention has resulted in a unique and unexpected combination of materials that captures impurities in wastewater and immobilizes these materials in a bonded chemical matrix thereby realizing synergistic properties previously unreported.

The ESFL technology is based on the simplicity of concrete production and the broad applicability of concrete to a wide spectrum of manufacturing and construction systems. Concrete production involves mixing cement (produced in a heated kiln from clay, limestone, gypsum, slag) with aggregate (stone, sand, gravel, etc.) and water. About one cubic yard of concrete is produced from mixing cement/aggregate and 30 gallons of water. Frack water replaces fresh “tap water” in the concrete when utilizing the ESFL system. The impurities from drilling are captured and neutralized permanently in the concrete matrix by inclusion of certain emulsifying chemicals (surfactants) that provide colloidal properties to frack water impurities. Once the concrete is set (cured) in a normal amount of time, the frack water impurities are permanently included in the concrete matrix. Bench scale tests conducted over the past several years have shown that the ESFL treated concrete has no odor of frack water, sets in a normal cure rate, and has extraction test characteristics indicating no frack water chemicals are “leached” out of the concrete.

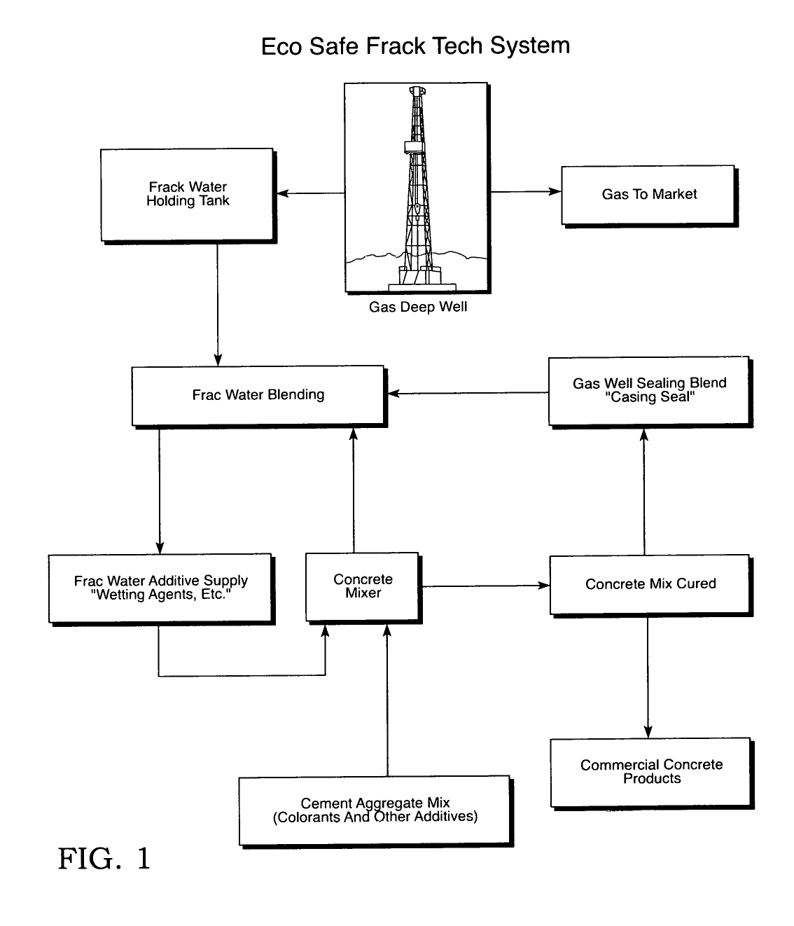

The ESFL technology is unique inasmuch as the surfactant and colloidal chemistry employed allow for the permanent capture of frack water impurities in the concrete matrix. A schematic diagram of the ESFL System can be seen in accompanying FIG. 1.

### Preliminary Economic Evaluation

Preliminary bench scale studies indicate economic savings of approximately one million dollars from a single drilling operation can result through the elimination of the need for deep well disposal. In addition, the potential sale of ancillary products from the matrix material can be expected. The need for the overall purchase of water should also be reduced somewhat as a result of this process.

The disposal of waste frack water is a significant concern to Marcellus Shale producers. Not only does the currently used treatment of frack water result in high costs, but the final disposal of the water can have environmental and community concerns. The ESFL Technology appears to not only eliminate disposal problems but also provides the potential for significant cost savings while providing concrete products for numerous marketable applications.

Although a thorough economic evaluation of the ESFL Technology may be premature with data from only bench scale experimentation, a “broad brush” examination of cost savings is of interest. Assuming that about 2 MM gallons of frack water is produced from each Marcellus shale well, the water would be injected with an appropriate amount of surfactant agent and the colloidal water mix would be added to a conventional concrete mixer (about 30 gallons of frack water for each yard of concrete product). The concrete product would be utilized for whatever commercial application desired presuming all other concrete properties are satisfied (such as cure time, compression, strength, etc.).

Accordingly, there will be about 20 cents/gallon savings or cost avoidance for transportation and deep well disposal (if feasible). In addition, the cost savings for purchase of fresh water at the concrete plant would be about $1/(1000 gallons). The cost savings could be significant for each well drilled proportional to the amount of wastewater. There should be a relatively large market for use of frack water in concrete applications if gas well drillers are willing to share the cost savings with concrete producers.

Uses for frack water concrete may include concrete for “well casings” for deep well drilling (FIG. 2) and “holding basin liners” at drilling well sites as well as numerous other concrete applications (concrete abutments, sidewalks, highway barriers, retaining walls, etc.).

The economic aspects of the process can better be estimated following field testing of the parameters at actual drilling sites, i.e. for the possible in situ manufacture of concrete products at or very near the gas/oil drilling site.

It is to be understood that the present invention is not limited to the foregoing particulars. Other modifications and variations are possible as appreciated by those skilled in the art in light of the foregoing.

What is claimed is:

1. A method for treating gas and oil drilling wastewater comprising:
(a) analyzing a sample of the wastewater for determining what contaminants are contained therein;
(b) treating the wastewater with one or more surfactants based on the contaminants present;
(c) providing a mixture of concrete components; and
(d) adding the treated wastewater to the concrete components for binding the treated wastewater in a matrix and forming one or more concrete products therefrom.

2. The method of claim 1 wherein step (d) is performed at or adjacent a gas and oil drilling operation.

3. The method of claim 1 wherein step (c) includes adding one or more colorants to the mixture of concrete components.

4. The method of claim 1 wherein step (b) includes adding one or more wetting agents to the wastewater.

5. The method of claim 1 wherein the concrete products resulting from step (d) include one or more of: a highway barrier, a residential driveway, a sidewalk, cement blocks and statuary decoratives.

6. The method of claim 1 wherein the concrete products resulting from step (d) include fracking well casings.

7. A method for safely disposing gas and oil drilling wastewater, said method comprising:
(a) analyzing a sample of the wastewater for determining what contaminants are contained therein;
(b) treating the wastewater with one or more surfactants and with wetting agents based on the contaminants detected in step (a);
(c) providing a mixture of concrete components; and
(d) adding the treated wastewater to the concrete components for binding the treated wastewater in a matrix and forming one or more concrete products therefrom.

8. The method of claim 7 wherein step (d) is performed at or adjacent a gas and oil drilling operation.

9. The method of claim 7 wherein step (c) includes adding one or colorants to the mixture of concrete components.

10. The method of claim 7 wherein the concrete products resulting from step (d) include one or more of: a highway barrier, a residential driveway, a sidewalk, cement blocks and statuary decoratives.

11. The method of claim 7 wherein the concrete products resulting from step (d) include fracking well casings.

12. A concrete product made from a mixture of dry concrete components to which has been added a gas and oil drilling wastewater treated with one or more surfactants selected for a plurality of contaminants present in the wastewater.

13. The concrete product of claim 12, which is a fracking well casing.

14. The concrete product of claim 13 wherein the concrete for said fracking well casing was mixed at or near the site of the fracking well.

15. The concrete product of claim 12, which is a highway barrier.

16. The concrete product of claim 12, which is a residential driveway or sidewalk.

17. The concrete product of claim 12, which is a cement block product.

18. The concrete product of claim 12, which is a decorative statuary.
